(19) United States
(12) Patent Application Publication
(10) Pub. No.: US 2022/0358735 A1
(43) Pub. Date: Nov. 10, 2022

(54) METHOD FOR PROCESSING IMAGE, DEVICE AND STORAGE MEDIUM

(71) Applicant: BEIJING BAIDU NETCOM SCIENCE TECHNOLOGY CO., LTD., Beijing (CN)

(72) Inventors: Bo JU, Beijing (CN); Zhikang ZOU, Beijing (CN); Xiaoqing YE, Beijing (CN); Xiao TAN, Beijing (CN); Hao SUN, Beijing (CN)

(21) Appl. No.: 17/875,124

(22) Filed: Jul. 27, 2022

(30) Foreign Application Priority Data
Sep. 29, 2021 (CN) 202111151493.5

(51) Int. Cl. G06T 19/00; G06T 7/11

(52) U.S. Cl. CPC G06T 19/006; G06T 7/11; G06T 2210/21

(57) ABSTRACT

A method for processing an image may include: acquiring a target image; segmenting a target object in the target image, and determining a mask image according to a segmentation result; rendering the target object according to the target image and the mask image and determining a rendering result; and performing AR displaying according to the rendering result. A device and storage medium may implement the method.

### CROSS-REFERENCE TO RELATED APPLICATIONS

The present application claims the priority of Chinese Patent Application No. 202111151493.5, titled “METHOD AND APPARATUS FOR PROCESSING IMAGE, DEVICE AND STORAGE MEDIUM”, filed on Sep. 29, 2021, the content of which is incorporated herein by reference in its entirety.

### TECHNICAL FIELD

The present disclosure relates to the field of artificial intelligence technology, and specifically to the fields of computer vision and deep learning technologies, and particularly to a method and apparatus for processing an image, a device and a storage medium, and can be used in 3D visual scenarios.

### BACKGROUND

The augmented reality (AR) technology is a technology that harmoniously combines virtual information and the real world, and widely uses various technical means such as multimedia, 3-dimensional modeling, real-time tracking and registration, intelligent interaction and sensing. The AR technology is to perform an analog simulation on computer-generated virtual information such as a text, an image, a 3-dimensional model, music, a video, and then apply the information to the real world, which makes two kinds of information complement each other, thereby realizing the “augmentation” of the real world.

The virtual reality (VR) technology includes computer technology, electronic information technology and simulation technology, and the basic implementation of the VR technology is that a computer simulates a virtual environment to give people a sense of environmental immersion.

### SUMMARY

The present disclosure provides a method and for processing an image, a device and a storage medium.

According to a first aspect, a method for processing image is provided, which includes: acquiring a target image; segmenting a target object in the target image, and determining a mask image according to a segmentation result; rendering the target object according to the target image and the mask image and determining a rendering result; and performing AR displaying according to the rendering result.

According to a second aspect, an electronic device is provided, which includes: at least one processor; and a storage device, communicated with the at least one processor, where the storage device stores an instruction executable by the at least one processor, and the instruction is executed by the at least one processor, to enable the at least one processor to perform the method according to the first aspect.

According to a third aspect, a non-transitory computer readable storage medium storing a computer instruction is provided, where the computer instruction is used to cause a computer to perform the method according to the first aspect.

It should be understood that the content described in this part is not intended to identify key or important features of the embodiments of the present disclosure, and is not used to limit the scope of the present disclosure. Other features of the present disclosure will be easily understood through the following description.

### BRIEF DESCRIPTION OF THE DRAWINGS

The accompanying drawings are used for a better understanding of the scheme, and do not constitute a limitation to the present disclosure. Here:

FIG. 1 is a diagram of an example system architecture in which an embodiment of the present disclosure may be applied;

FIG. 2 is a flowchart of an embodiment of a method for processing an image according to the present disclosure;

FIG. 3 is a schematic diagram of an application scenario of the method for processing an image according to the present disclosure;

FIG. 4 is a flowchart of another embodiment of the method for processing an image according to the present disclosure;

FIG. 5 is a schematic structural diagram of an embodiment of an apparatus for processing an image according to the present disclosure; and

FIG. 6 is a block diagram of an electronic device adapted to implement the method for processing an image according to embodiments of the present disclosure.

### DETAILED DESCRIPTION OF EMBODIMENTS

Example embodiments of the present disclosure are described below in combination with the accompanying drawings, and various details of the embodiments of the present disclosure are included in the description to facilitate understanding, and should be considered as example only. Accordingly, it should be recognized by one of ordinary skill in the art that various changes and modifications may be made to the embodiments described herein without departing from the scope and spirit of the present disclosure. Also, for clarity and conciseness, descriptions for well-known functions and structures are omitted in the following description.

It should be noted that the embodiments in the present disclosure and the features in the embodiments may be combined with each other on a non-conflict basis. The present disclosure will be described below in detail with reference to the accompanying drawings and in combination with the embodiments.

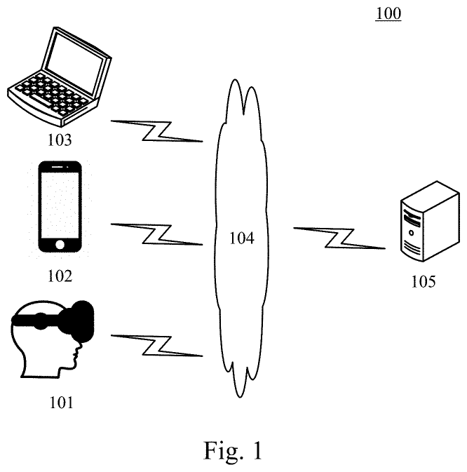

FIG. 1 illustrates an example system architecture 100 in which an embodiment of a method for processing an image or an apparatus for processing an image according to the present disclosure may be applied.

As shown in FIG. 1, the system architecture 100 may include terminal devices 101, 102 and 103, a network 104 and a server 105. The network 104 serves as a medium providing a communication link between the terminal devices 101, 102 and 103 and the server 105. The network 104 may include various types of connections, for example, wired or wireless communication links, or optical fiber cables.

A user may use the terminal devices 101, 102 and 103 to interact with the server 105 through the network 104, to receive or send a message, etc. Various communication client applications (e.g., an image processing application) may be installed on the terminal devices 101, 102 and 103.

The terminal devices 101, 102 and 103 may be hardware or software. When being the hardware, the terminal devices 101, 102 and 103 may be various electronic devices, the electronic devices including, but not limited to, an AR display device, a VR display device, a smart phone, a tablet computer, a laptop portable computer, a desktop computer, and the like. When being the software, the terminal devices 101, 102 and 103 may be installed in the above listed electronic devices. The terminal devices may be implemented as a plurality of pieces of software or a plurality of software modules (e.g., software or software modules for providing a distributed service), or may be implemented as a single piece of software or a single software module, which will not be specifically limited here.

The server 105 may be a server providing various services, for example, a backend server processing the image provided by the terminal devices 101, 102 and 103. The backend server may process the image to pseudo-holographic content, render the pseudo-holographic content and feed back the rendered content to the terminal devices 101, 102 and 103. The terminal devices 101, 102 and 103 may perform AR displaying on the rendered content.

It should be noted that the server 105 may be hardware or software. When being the hardware, the server 105 may be implemented as a distributed server cluster composed of a plurality of servers, or may be implemented as a single server. When being the software, the server 105 may be implemented as a plurality of pieces of software or a plurality of software modules (e.g., software or software modules for providing a distributed service), or may be implemented as a single piece of software or a single software module, which will not be specifically limited here.

It should be noted that the method for processing an image provided in the embodiment of the present disclosure is generally performed by the terminal devices 101, 102 and 103. Correspondingly, the apparatus for processing an image is generally provided in the terminal devices 101, 102 and 103.

It should be appreciated that the numbers of the terminal devices, the networks, and the servers in FIG. 1 are merely illustrative. Any number of terminal devices, networks, and servers may be provided based on actual requirements.

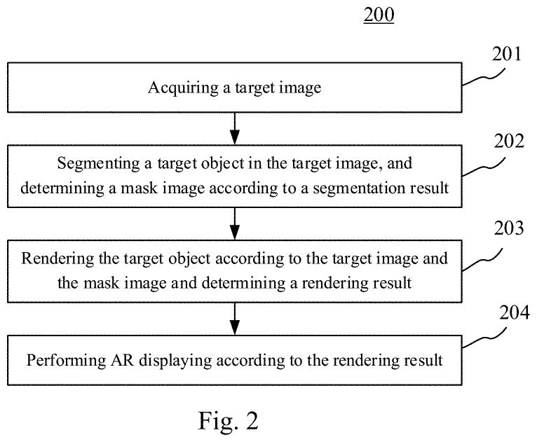

Further referring to FIG. 2, FIG. 2 illustrates a flow 200 of an embodiment of a method for processing an image according to the present disclosure. The method for processing an image in this embodiment includes the following steps.

Step 201 includes acquiring a target image.

In this embodiment, an executing body of the method for processing an image may acquire the target image in various ways. Here, the target image may include a target object. The target object may be an item or a person.

Step 202 includes segmenting a target object in the target image, and determining a mask image according to a segmentation result.

The executing body may segment the target object in the target image. Specifically, if the target object is a person, the executing body may use a human body segmentation network to perform a human body segmentation. If the target object is an item, a pre-trained network may be used to perform an item segmentation. The segmentation result includes an area occupied by the target object, and may further include an outline of the target object. After the area occupied by the target object or the outline is determined, the mask image may be determined. Specifically, the values of the pixels in the area occupied by the target object may be set to (255, 255, 255), and the values of the pixels outside the area occupied by the target object may be set to (0, 0, 0). The size of the mask image may be a preset size, or the same size as the target image.

Step 203 includes rendering the target object according to the target image and the mask image and determining a rendering result.

After the mask image is determined, the executing body may render the target object according to the target image and the mask image, and determine the rendering result. Specifically, the executing body may superimpose the target image and the mask image, set the transparencies of pixels outside the target object to 0, and set the transparencies of pixels within the target object to 1. In this way, the pixel value of each pixel of the target object may be displayed at the time of display.

Step 204 includes performing AR displaying according to the rendering result.

After obtaining the rendering result, the executing body may display the rendering result at an AR client. Specifically, the executing body may display the rendering result at any position of the AR client. Alternatively, the rendering result may be displayed on a preset object displayed in the AR client, for example, displayed on a plane.

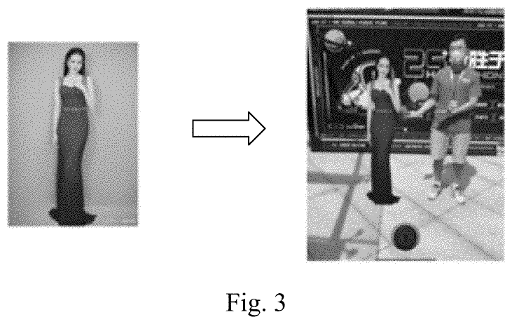

Further referring to FIG. 3, FIG. 3 is a schematic diagram of an application scenario of the method for processing an image according to the present disclosure. In the application scenario of FIG. 3, a user acquires a target video of a target person, and the image of the target person is displayed at an AR display terminal by processing each video frame in the target video.

According to the method for processing an image provided in the above embodiment of the present disclosure, it is possible to change the image of the target object into a pseudo-holographic image, and show the pseudo-holographic image by using the AR technology, thus improving the AR display efficiency for three dimensional object.

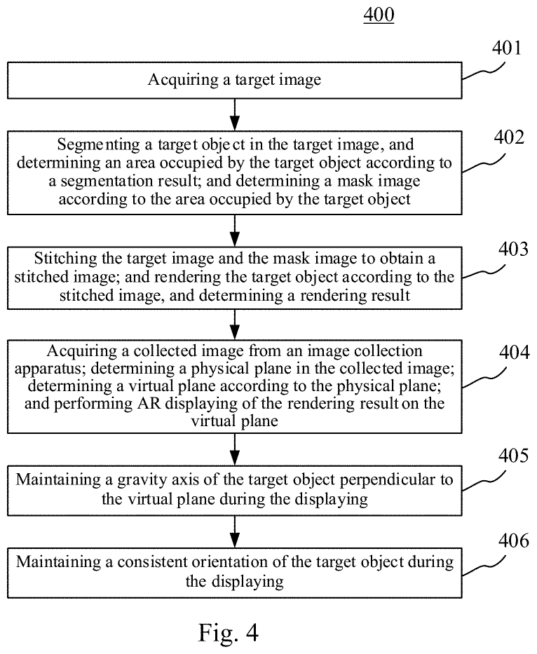

Further referring to FIG. 4, FIG. 4 illustrates a flow 400 of another embodiment of the method for processing an image according to the present disclosure. As shown in FIG. 4, the method in this embodiment may include the following steps.

Step 401 includes acquiring a target image.

Step 402 includes segmenting a target object in the target image, and determining an area occupied by the target object according to a segmentation result; and determining a mask image according to the area occupied by the target object.

The executing body may segment the target object in the target image, and determine the segmentation result. According to the segmentation result, the area occupied by the target object is determined. After the area occupied by the target object is determined, the pixels in the above area may be set to (255, 255, 255), and the values of the pixels outside the above area may be set to (0, 0, 0). Alternatively, the executing body may also set different transparencies for different pixels of the mask image. For example, the transparency of each pixel is associated with the position of the each pixel.

Step 403 includes stitching the target image and the mask image to obtain a stitched image; and rendering the target object according to the stitched image, and determining a rendering result.

After obtaining the mask image, the executing body may stitch the target image and the mask image together. The image obtained by stitching is referred to as the stitched image. Specifically, the executing body may set the size of the target image and the size of the mask image to be the same, and the shapes of the target image and the mask image are both rectangles. During the stitching, the right border of the target image and the left border of the mask image may be aligned to obtain a stitched image. Alternatively, the upper border of the target image and the lower border of the mask image may be aligned to obtain a stitched image.

After obtaining the stitched image, the executing body may render the target object and determine the rendering result. Specifically, the target image and the mask image may be compared to determine the pixel value of each pixel, thereby obtaining the rendering result.

In some alternative implementations of this embodiment, in the above stitched image, the sizes of the target image and the mask image are identical, and the positions of the target object in the target image and the mask image are identical. Here, the positions of the target object are identical may be understood as that, the distances between pixel points of the target object of the target image and the border of the target image, are equal to distances between pixel points of the target object of the mask image and the border of the mask image.

The executing body may implement the rendering on the target object by: determining a pixel value and a transparency value corresponding to each pixel point according to the stitched image; and determining a rendered pixel value of the each pixel point according to the pixel value and the transparency value.

In this implementation, since the positions of the target object in the target image and the mask image are identical, matching may be performed on pixel points in the target image and pixel points in the mask image, and the pixel values and transparencies of two matching pixel points may be used to calculate the rendered pixel value. For example, the target image is on the left portion of the stitched image, and the mask image is on the right portion of the stitched image. A user may query the pixel values of pixel points (u, v). Here, the values of u and v are both between (0, 1). Here, the position of each pixel point is represented using a value between (0, 1), which can avoid a calculation error caused by the change of the position of the pixel point due to the change of the image size.

The executing body may determine whether the queried pixel point is on the left portion of the stitched image or on the right portion of the stitched image according to the value of u. If the pixel point is on the left portion of the stitched image, the RGB value of the queried pixel point may be determined. At the same time, the transparency of a matching pixel point in the right portion of the stitched image may be determined. Then, the RGB value is multiplied by the transparency, to obtain a final rendered pixel value. Similarly, if the queried pixel point is on the right portion of the image, the transparency of the pixel point may be first determined. Then, according to a matching point, the RGB value of the pixel point is determined. Finally, the rendered pixel value is calculated.

It can be understood that the executing body may perform the rendering through a GPU (graphics processing unit). When performing the rendering, the GPU needs to first read the stitched image into a memory, and then read the above stitched image through a shader.

Step 404 includes acquiring a collected image from an image collection apparatus; determining a physical plane in the collected image; determining a virtual plane according to the physical plane; and performing AR displaying on the rendering result on the virtual plane.

The executing body may further acquire the collected image from the image collection apparatus. Since the AR displaying is performed, the image collection apparatus may be called to perform an image collection during the displaying. The above image collection apparatus may be a camera installed in a terminal. The executing body may analyze the collected image to determine the physical plane included in the collected image. Here, the physical plane refers to a specific plane in the collected image. For example, the physical plane may be a desktop, ground, etc.

The executing body may determine the virtual plane according to the physical plane. Specifically, the executing body may directly use the plane where the physical plane is as the virtual plane. Alternatively, the virtual plane is obtained by estimating the physical plane using an SLAM (simultaneous localization and mapping) algorithm. Then, the AR displaying of the rendering result is performed on the virtual plane.

In some alternative implementations of this embodiment, the executing body may implement the AR displaying through the following steps not shown in FIG. 4: acquiring a two-dimensional position point inputted by a user on the virtual plane; transforming, according to a preset transformation parameter, the two-dimensional position point into a three-dimensional space to obtain a three-dimensional position point, and transforming the virtual plane into the three-dimensional space to obtain a three-dimensional plane; using an intersection of a line connecting the three-dimensional position point with an origin and the three-dimensional plane as a display position of the target object; and performing the AR displaying of the rendering result at the display position.

In this implementation, the executing body may first establish a world coordinate system, and the origin of the world coordinate system is obtained by perform an initialization using the SLAM algorithm. Moreover, this implementation also allows the user to customize the display position of the target object. Specifically, the user may input the two-dimensional position point in the virtual plane. Then, the executing body may transform the two-dimensional position point into a three-dimensional space according to the intrinsic parameters and extrinsic parameters of the camera, to obtain a three-dimensional position point. At the same time, the executing body may further use the intrinsic parameters and the extrinsic parameters to transform the virtual plane into the three-dimensional space to obtain a three-dimensional plane. Then, the intersection of the line connecting the above three-dimensional position point with a camera origin and the three-dimensional plane is used as the display position of the target object. Then, the AR displaying of the rendering result is performed at the above display position.

Step 405 includes maintaining a gravity axis of the target object perpendicular to the virtual plane during the displaying.

In this embodiment, during the AR displaying, in order to maintain the viewing experience of the user or improve the interactive performance, the executing body may maintain the gravity axis of the target object perpendicular to the virtual plane all the time.

Specifically, the executing body may preset the gravity axis of the target object, as long as the gravity axis is set to be parallel to the normal line of the virtual plane.

Step 406 including maintaining a consistent orientation of the target object during the displaying.

In this embodiment, during the AR displaying, the executing body may preset the orientation of the target object. For example, the above orientation is toward the front of the screen. The executing body may set the direction of an coordinate axis to represent the orientation of the target object. During the displaying, the executing body may monitor the rotation angle of the image collection apparatus in real time, and then rotate the orientation of the target object by the angle.

According to the method for processing an image provided in the above embodiment of the present disclosure, the target object may be displayed at the AR client in the form of pseudo-holography, which does not require complicated calculation, thus improving the display efficiency of the object in the AR client.

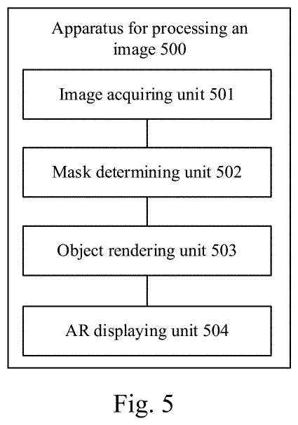

Further referring to FIG. 5, as an implementation of the method shown in the above drawing, the present disclosure provides an embodiment of an apparatus for processing an image. The embodiment of the apparatus corresponds to the embodiment of the method shown in FIG. 2. The apparatus may be applied in various electronic devices.

As shown in FIG. 5, an apparatus 500 for processing an image in this embodiment includes: an image acquiring unit 501, a mask determining unit 502, an object rendering unit 503 and an AR displaying unit 504.

The image acquiring unit 501 is configured to acquire a target image.

The mask determining unit 502 is configured to segment a target object in the target image, and determine a mask image according to a segmentation result.

The object rendering unit 503 is configured to render the target object according to the target image and the mask image and determine a rendering result.

The AR displaying unit 504 is configured to perform AR displaying according to the rendering result.

In some alternative implementations of this embodiment, the mask determining unit 502 may be further configured to: determine an area occupied by the target object according to the segmentation result; and determine the mask image according to the area occupied by the target object.

In some alternative implementations of this embodiment, the object rendering unit 503 may be further configured to: stitch the target image and the mask image to obtain a stitched image; and render the target object according to the stitched image and determine the rendering result.

In some alternative implementations of this embodiment, in the stitched image, a size of the target image and a size of the mask image are identical, and positions of the target object in the target image and the mask image are identical. The object rendering unit 503 may be further configured to: determine a pixel value and a transparency value corresponding to each pixel point according to the stitched image; and determine a rendered pixel value of each pixel point according to the pixel value and the transparency value.

In some alternative implementations of this embodiment, the AR displaying unit 504 may be further configured to: acquire a collected image from an image collection apparatus; determine a physical plane in the collected image; determine a virtual plane according to the physical plane; and perform the AR displaying on the rendering result on the virtual plane.

In some alternative implementations of this embodiment, the AR displaying unit 504 may be further configured to: acquire a two-dimensional position point inputted by a user on the virtual plane; transform, according to a preset transformation parameter, the two-dimensional position point into a three-dimensional space to obtain a three-dimensional position point, and transform the virtual plane into the three-dimensional space to obtain a three-dimensional plane; use an intersection of a line connecting the three-dimensional position point with an origin and the three-dimensional plane as a display position of the target object; and perform the AR displaying of the rendering result at the display position.

In some alternative implementations of this embodiment, the AR displaying unit 504 may be further configured to: maintain a gravity axis of the target object perpendicular to the virtual plane during the displaying.

In some alternative implementations of this embodiment, the AR displaying unit 504 may be further configured to: maintain a consistent orientation of the target object during the displaying.

It should be understood that, the units 501-504 described in the apparatus 500 for processing an image respectively correspond to the steps in the method described with reference to FIG. 2. Accordingly, the above operations and features described for the method for processing an image are also applicable to the apparatus 500 and the units included therein, and thus will not be repeatedly described here.

In the technical solution of the present disclosure, the collection, storage, use, processing, transmission, provision, disclosure, etc. of the personal information of a user all comply with the provisions of the relevant laws and regulations, and do not violate public order and good customs.

According to an embodiment of the present disclosure, the present disclosure further provides an electronic device, a readable storage medium, and a computer program product.

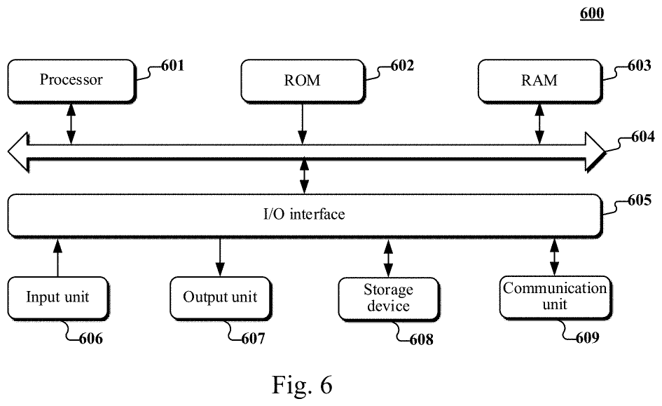

FIG. 6 is a block diagram of an electronic device 600 performing the method for processing an image, according to the embodiments of the present disclosure. The electronic device is intended to represent various forms of digital computers such as a laptop computer, a desktop computer, a workstation, a personal digital assistant, a server, a blade server, a mainframe computer, and other appropriate computers. The electronic device may also represent various forms of mobile apparatuses such as personal digital assistant, a cellular telephone, a smart phone, a wearable device and other similar computing apparatuses. The parts shown herein, their connections and relationships, and their functions are only as examples, and not intended to limit implementations of the present disclosure as described and/or claimed herein.

As shown in FIG. 6, the electronic device 600 includes a processor 601 that can perform various appropriate actions and processes according to a computer program stored in a read only memory (ROM) 602 or a computer program loaded from the memory 608 into a random access memory (RAM) 603. In RAM 603, various programs and data required for the operation of electronic device 600 can also be stored. The processor 601, ROM 602 and RAM 603 are connected to each other through bus 604. The I/O interface (input/output interface) 605 is also connected to the bus 604.

A plurality of components in the device 600 are connected to the I/O interface 605, including: an input unit 606, such as a keyboard, a mouse and the like; an output unit 607, such as various types of displays, speakers, and the like; a storage unit 608, such as a magnetic disk, an optical disc, and the like; and a communication unit 609, such as a network card, a modem, a wireless communication transceiver and the like. The communication unit 609 allows the device 600 to exchange information/data with other devices through computer networks such as the Internet and/or various telecommunication networks.

The processor 601 may be various general-purpose and/or special-purpose processing components with processing and computing capabilities. Some examples of the processor 601 include, but are not limited to, a central processing unit (CPU), a graphics processing unit (GPU), various dedicated artificial intelligence (AI) computing chips, various processors running machine learning model algorithms, digital signal processors (DSPS), and any suitable processor, controller, microcontroller, etc. The processor 601 performs various methods and processes described above, such as a method for processing an image. For example, in some embodiments, a method for processing an image may be implemented as a computer software program that is tangibly contained in a machine-readable storage medium, such as memory 608. In some embodiments, part or all of the computer program may be loaded and/or installed on the electronic device 600 via ROM 602 and/or communication unit 609. When the computer program is loaded into RAM 603 and executed by processor 601, one or more steps of the method for processing an image described above may be performed. Alternatively, in other embodiments, the processor 601 may be configured to perform a method for processing an image by any other suitable means (E. G., by means of firmware).

Various implementations of the systems and technologies described above herein may be implemented in a digital electronic circuit system, an integrated circuit system, a field programmable gate array (FPGA), an application specific integrated circuit (ASIC), an application specific standard product (ASSP), a system on a chip (SOC), a complex programmable logic device (CPLD), computer hardware, firmware, software, and/or a combination thereof. The various implementations may include: being implemented in one or more computer programs, where the one or more computer programs may be executed and/or interpreted on a programmable system including at least one programmable processor, and the programmable processor may be a specific-purpose or general-purpose programmable processor, which may receive data and instructions from a storage system, at least one input apparatus and at least one output apparatus, and send the data and instructions to the storage system, the at least one input apparatus and the at least one output apparatus.

Program codes for implementing the method of the present disclosure may be compiled using any combination of one or more programming languages. The program codes may be provided to a processor or controller of a general purpose computer, a specific purpose computer, or other programmable apparatuses for data processing, such that the program codes, when executed by the processor or controller, cause the functions/operations specified in the flowcharts and/or block diagrams to be implemented. The program codes may be completely executed on a machine, partially executed on a machine, partially executed on a machine and partially executed on a remote machine as a separate software package, or completely executed on a remote machine or server.

In the context of the present disclosure, a machine readable medium may be a tangible medium which may contain or store a program for use by, or used in combination with, an instruction execution system, apparatus or device. The machine readable medium may be a machine readable signal medium or a machine readable storage medium. The computer readable medium may include, but is not limited to, electronic, magnetic, optical, electromagnetic, infrared, or semiconductor systems, apparatuses, or devices, or any appropriate combination of the above. A more specific example of the machine readable storage medium will include an electrical connection based on one or more pieces of wire, a portable computer disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device, or any appropriate combination of the above.

To provide interaction with a user, the systems and technologies described herein may be implemented on a computer that is provided with: a display apparatus (e.g., a CRT (cathode ray tube) or an LCD (liquid crystal display) monitor) configured to display information to the user; and a keyboard and a pointing apparatus (e.g., a mouse or a trackball) by which the user can provide an input to the computer. Other kinds of apparatuses may also be configured to provide interaction with the user. For example, feedback provided to the user may be any form of sensory feedback (e.g., visual feedback, auditory feedback, or tactile feedback); and an input may be received from the user in any form (including an acoustic input, a voice input, or a tactile input).

The systems and technologies described herein may be implemented in a computing system that includes a back-end component (e.g., as a data server), or a computing system that includes a middleware component (e.g., an application server), or a computing system that includes a front-end component (e.g., a user computer with a graphical user interface or a web browser through which the user can interact with an implementation of the systems and technologies described herein), or a computing system that includes any combination of such a back-end component, such a middleware component, or such a front-end component. The components of the system may be interconnected by digital data communication (e.g., a communication network) in any form or medium. Examples of the communication network include: a local area network (LAN), a wide area network (WAN), and the Internet.

The computer system may include a client and a server. The client and the server are generally remote from each other, and generally interact with each other through a communication network. The relationship between the client and the server is generated by virtue of computer programs that run on corresponding computers and have a client-server relationship with each other. The server can be a cloud server, also known as cloud computing server or cloud host. It is a host product in the cloud computing service system to solve the defects of difficult management and weak business scalability in the traditional physical host and VPS service (“virtual private server”, or “VPS”). The server may alternatively be a distributed system server or a blockchain server.

It should be understood that the various forms of processes shown above may be used to reorder, add, or delete steps. For example, the steps disclosed in the present disclosure may be executed in parallel, sequentially, or in different orders, as long as the desired results of the technical solutions mentioned in the present disclosure can be implemented. This is not limited herein.

The above specific implementations do not constitute any limitation to the scope of protection of the present disclosure. It should be understood by those skilled in the art that various modifications, combinations, sub-combinations, and replacements may be made according to the design requirements and other factors. Any modification, equivalent replacement, improvement, and the like made within the spirit and principle of the present disclosure should be encompassed within the scope of protection of the present disclosure.

What is claimed is:

1. A method for processing an image, comprising:
acquiring a target image;
segmenting a target object in the target image, and determining a mask image according to a segmentation result;
rendering the target object according to the target image and the mask image, and determining a rendering result; and
performing augmented reality (AR) displaying according to the rendering result.

2. The method according to claim 1, wherein determining the mask image according to the segmentation result comprises:
determining an area occupied by the target object according to the segmentation result; and
determining the mask image according to the area occupied by the target object.

3. The method according to claim 1, wherein rendering the target object according to the target image and the mask image, and determining the rendering result comprises:
stitching the target image and the mask image to obtain a stitched image; and
rendering the target object according to the stitched image and determining the rendering result.

4. The method according to claim 3, wherein, in the stitched image, a size of the target image and a size of the mask image are identical, and a position of the target object in the target image and a position of the target object in the mask image are identical, and
rendering the target object according to the stitched image and determining the rendering result comprises:
determining a pixel value and a transparency value corresponding to each pixel point according to the stitched image; and
determining a rendered pixel value of each pixel point according to the pixel value and the transparency value.

5. The method according to claim 1, wherein performing AR displaying according to the rendering result comprises:
acquiring a collected image from an image collection apparatus;
determining a physical plane in the collected image;
determining a virtual plane according to the physical plane; and
performing the AR displaying on the rendering result on the virtual plane.

6. The method according to claim 5, wherein performing the AR displaying on the rendering result on the virtual plane further comprises:
acquiring a two-dimensional position point inputted by a user on the virtual plane;
transforming, according to a preset transformation parameter, the two-dimensional position point into a three-dimensional space to obtain a three-dimensional position point, and transforming the virtual plane into the three-dimensional space to obtain a three-dimensional plane;
using an intersection of a line connecting the three-dimensional position point with an origin and the three-dimensional plane as a display position of the target object; and
performing the AR displaying of the rendering result at the display position.

7. The method according to claim 5, wherein performing AR displaying according to the rendering result further comprises:
maintaining a gravity axis of the target object perpendicular to the virtual plane during the displaying.

8. The method according to claim 1, wherein performing the AR displaying according to the rendering result comprises:
maintaining a consistent orientation of the target object during the displaying.

9. An electronic device, comprising:
at least one processor; and
a non-transitory storage device, communicated with the at least one processor,
wherein the storage device stores instructions executable by the at least one processor, and the instructions when executed by the at least one processor cause the at least one processor to perform operations comprising:
acquiring a target image;
segmenting a target object in the target image, and determining a mask image according to a segmentation result;
rendering the target object according to the target image and the mask image, and determining a rendering result; and
performing augmented reality (AR) displaying according to the rendering result.

10. The electronic device according to claim 9, wherein determining the mask image according to the segmentation result comprises:
determining an area occupied by the target object according to the segmentation result; and
determining the mask image according to the area occupied by the target object.

11. The electronic device according to claim 9, wherein rendering the target object according to the target image and the mask image, and determining the rendering result comprises:
stitching the target image and the mask image to obtain a stitched image; and
rendering the target object according to the stitched image and determining the rendering result.

12. The electronic device according to claim 11, wherein, in the stitched image, a size of the target image and a size of the mask image are identical, and a position of the target object in the target image and a position of the target object in the mask image are identical, and
rendering the target object according to the stitched image and determining the rendering result comprises:
determining a pixel value and a transparency value corresponding to each pixel point according to the stitched image; and
determining a rendered pixel value of each pixel point according to the pixel value and the transparency value.

13. The electronic device according to claim 9, wherein performing AR displaying according to the rendering result comprises:
acquiring a collected image from an image collection apparatus;
determining a physical plane in the collected image;
determining a virtual plane according to the physical plane; and
performing the AR displaying on the rendering result on the virtual plane.

14. The electronic device according to claim 13, wherein performing the AR displaying on the rendering result on the virtual plane further comprises:
acquiring a two-dimensional position point inputted by a user on the virtual plane;
transforming, according to a preset transformation parameter, the two-dimensional position point into a three-dimensional space to obtain a three-dimensional position point, and transforming the virtual plane into the three-dimensional space to obtain a three-dimensional plane;
using an intersection of a line connecting the three-dimensional position point with an origin and the three-dimensional plane as a display position of the target object; and
performing the AR displaying of the rendering result at the display position.

15. The electronic device according to claim 13, wherein performing AR displaying according to the rendering result further comprises:
maintaining a gravity axis of the target object perpendicular to the virtual plane during the displaying.

16. The electronic device according to claim 9, wherein performing the AR displaying according to the rendering result comprises:
maintaining a consistent orientation of the target object during the displaying.

17. A non-transitory computer readable storage medium, storing computer instructions, wherein the computer instructions when executed by a computer cause the computer to perform operations comprising:
acquiring a target image;
segmenting a target object in the target image, and determining a mask image according to a segmentation result;
rendering the target object according to the target image and the mask image, and determining a rendering result; and
performing augmented reality (AR) displaying according to the rendering result.

18. The storage medium according to claim 17, wherein determining the mask image according to the segmentation result comprises:
determining an area occupied by the target object according to the segmentation result; and
determining the mask image according to the area occupied by the target object.

19. The storage medium according to claim 17, wherein rendering the target object according to the target image and the mask image and determining the rendering result comprises:
stitching the target image and the mask image to obtain a stitched image; and
rendering the target object according to the stitched image and determining the rendering result.

20. The storage medium according to claim 19, wherein, in the stitched image, a size of the target image and a size of the mask image are identical, and a position of the target object in the target image and a position of the target object in the mask image are identical, and
rendering the target object according to the stitched image and determining the rendering result comprises:
determining a pixel value and a transparency value corresponding to each pixel point according to the stitched image; and
determining a rendered pixel value of each pixel point according to the pixel value and the transparency value.
